(19) United States
(12) Patent Application Publication
(10) Pub. No.: US 2026/0061750 A1
(43) Pub. Date: Mar. 5, 2026

(54) LIQUID EJECTION APPARATUS

(71) Applicant: SEIKO EPSON CORPORATION, Tokyo (JP)

(72) Inventors: Tomoya KURASHINA, SHIOJIRI-SHI (JP); Sho ARUGA, CHINO-SHI (JP); Soshi OKAWA, SHIOJIRI-SHI (JP); Haruki MIYASAKA, MATSUMOTO-SHI (JP); Nobuhiko SHINOZAKI, OKAYA-SHI (JP)

(21) Appl. No.: 19/315,926

(22) Filed: Sep. 2, 2025

(30) Foreign Application Priority Data
Sep. 3, 2024 (JP) 2024-151626

(51) Int. Cl. B41J 2/165; B41J 13/076; B41J 25/304; B41J 29/17

(52) U.S. Cl. CPC B41J 2/16538; B41J 2/16585; B41J 13/076; B41J 25/304; B41J 29/17; B41P 2235/21

(57) ABSTRACT

A liquid ejection apparatus includes a liquid ejection head, a wiper that wipes a head surface with nozzles provided thereon in the liquid ejection head by moving with respect to the head surface to wipe the head surface, and at least one contact member provided integrally with the liquid ejection head and configured to come into contact with the medium conveyed between the head surface and a facing portion, wherein the contact member is displaceable between a first position and a second position that are relative positions to the head surface, the first position is a position at which the contact member is allowed to interfere with the wiper and come into contact with the medium, and the second position is a position at which the contact member is not allowed to interfere with the wiper.

The present application is based on, and claims priority from JP Application Serial Number 2024-151626, filed Sep. 3, 2024, the disclosure of which is hereby incorporated by reference herein in its entirety.

### BACKGROUND

### 1. Technical Field

The present disclosure relates to a liquid ejection apparatus that ejects a liquid onto a medium.

### 2. Related Art

In a printer as an example of a liquid ejection apparatus, a technique of suppressing contact of a sheet with a head surface of an inkjet head has been adopted in the related art. As an example thereof, JP-A-2009-262544 discloses a printer using a line-type inkjet head in which a plurality of head units and a plurality of spurs are alternately arranged along a predetermined direction. The spurs press the recording sheet to suppress warpage of the recording sheet.

Further, the printer in JP-A-2009-262544 includes a wiper that wipes the ink ejection surface of the head unit. A plurality of wipers are provided on the support member so as to correspond to the ink ejection surfaces. The support member is normally retracted to a position away from the inkjet head. During wiping, the inkjet head rises, and the support member with the wipers moves to a predetermined space facing the ink ejection surfaces of the inkjet head. Then, when the inkjet head is lowered and the ink ejection surfaces and the wipers are brought into contact with each other, the support member moves along the main scanning direction, whereby the wipers wipe off the ink attached to the ink ejection surfaces.

JP-A-2009-262544 is an example of the related art.

In the printer described in JP-A-2009-262544, since the plurality of head units and the plurality of spurs are alternately arranged along the predetermined direction, it is necessary to provide the plurality of wipers so as to correspond to the respective ink ejection surfaces, which causes an increase in cost of the apparatus. In addition, in such a configuration, for replacement of the wipers, the man-hour for work and the component cost are significantly increased.

### SUMMARY

A liquid ejection apparatus according to an aspect of the present disclosure includes a liquid ejection head including a plurality of nozzles that eject liquid onto a medium, a facing portion disposed to face the liquid ejection head, a wiper that wipes a head surface with the nozzles provided thereon in the liquid ejection head by moving with respect to the head surface to wipe the head surface, and at least one contact member provided integrally with the liquid ejection head and configured to come into contact with the medium conveyed between the head surface and the facing portion, wherein the contact member is displaceable between a first position and a second position that are relative positions to the head surface, the first position is a position at which the contact member is allowed to interfere with the wiper and come into contact with the medium, and the second position is a position at which the contact member is not allowed to interfere with the wiper.

### BRIEF DESCRIPTION OF THE DRAWINGS

FIG. 1 shows an entire medium conveyance path of a printer.

FIG. 2 shows a drive mechanism for moving up and down a line head.

FIG. 3 shows an operation of a wiper.

FIG. 4 is a perspective view of the line head as viewed from below.

FIG. 5 is a plan view of a head surface.

FIG. 6A shows a displacement mechanism for displacing a contact member with the line head located at a recording position.

FIG. 6B shows the displacement mechanism for displacing the contact member with the line head located between the recording position and a retracted position.

FIG. 6C shows the displacement mechanism for displacing the contact member with the line head located at the retracted position.

FIG. 7 is a plan view of the head surface.

FIG. 8 is a perspective view of the line head as viewed from below.

FIG. 9A shows a displacement mechanism for displacing the contact member with the line head located at a recording position.

FIG. 9B shows the displacement mechanism for displacing the contact member with the line head located between the recording position and a retracted position.

FIG. 9C shows the displacement mechanism for displacing the contact member with the line head located between the recording position and the retracted position.

FIG. 9D shows the displacement mechanism for displacing the contact member with the line head located at the retracted position.

FIG. 10 shows a displacement mechanism for displacing the contact member with cleaning members provided therein.

### DESCRIPTION OF EMBODIMENTS

The present disclosure will be schematically described below.

A liquid ejection apparatus having a first configuration includes a liquid ejection head including a plurality of nozzles that eject liquid onto a medium, a facing portion disposed to face the liquid ejection head, a wiper that wipes a head surface with the nozzles provided thereon in the liquid ejection head by moving with respect to the head surface to wipe the head surface, and at least one contact member provided integrally with the liquid ejection head and configured to come into contact with the medium conveyed between the head surface and the facing portion, wherein the contact member is displaceable between a first position and a second position that are relative positions to the head surface, the first position is a position at which the contact member is allowed to interfere with the wiper and come into contact with the medium, and the second position is a position at which the contact member is not allowed to interfere with the wiper.

According to the present configuration, the contact member is set at the first position, and thus the contact of the medium with the head surface can be suppressed.

The contact member is set at the second position, and thus the contact member can be prevented from becoming an obstacle when the head surface is wiped by the wiper. Therefore, it is not necessary to dispose a plurality of the wipers so as to avoid the contact member, and an increase in cost of the apparatus can be suppressed. In addition, for replacement of the wiper, a significant increase in man-hour for work and component cost can be suppressed.

In a second configuration according to the first configuration, the liquid ejection head is displaceable between a recording position where recording is performed on the medium and a retracted position farther from the facing portion than the recording position, at which the wiper is received between the head surface and the facing portion, the contact member is located at the first position when the liquid ejection head is at the recording position, the contact member is located at the second position when the liquid ejection head is at the retracted position, and a displacement mechanism that displaces the contact member converts a displacement movement of the liquid ejection head into a displacement movement of the contact member, displaces the contact member from the first position to the second position when the liquid ejection head is displaced from the recording position to the retracted position, and displaces the contact member from the second position to the first position when the liquid ejection head is displaced from the retracted position to the recording position.

According to the present configuration, since the displacement movement of the liquid ejection head is converted into the displacement movement of the contact member, the contact member is displaced from the first position to the second position when the liquid ejection head is displaced from the recording position to the retracted position, and the contact member is displaced from the second position to the first position when the liquid ejection head is displaced from the retracted position to the recording position, a power source for displacing the contact member is unnecessary, and an increase in cost of the apparatus can be suppressed.

In a third aspect according to the second configuration, the contact member is displaced to the first position and the second position by moving in directions intersecting the head surface.

According to the present configuration, since the contact member is configured to move in the directions intersecting the head surface, an increase in size of the liquid ejection head in the conveyance direction can be suppressed as compared with a configuration in which the contact member moves along the conveyance direction of the medium.

Note that the present configuration may be dependent from not only the second configuration but also the first configuration.

In a fourth configuration according to the third configuration, the displacement mechanism includes a support member supporting the contact member and configured to change an attitude to a first pivot attitude to set the contact member at the first position and a second pivot attitude to set the contact member at the second position by pivoting, and a cam member provided independently of the liquid ejection head and configured to engage with the support member, wherein the cam member guides the support member from the first pivot attitude to the second pivot attitude when the liquid ejection head is displaced from the recording position to the retracted position, and guides the support member from the second pivot attitude to the first pivot attitude when the liquid ejection head is displaced from the retracted position to the recording position.

According to the present configuration, the contact member can be displaced in conjunction with the displacement movement of the liquid ejection head with the simple configuration using the support member and the cam member.

Note that the present configuration may be dependent from not only the third configuration but also the second configuration.

In a fifth configuration according to the second configuration, the contact member is displaced to the first position and the second position by moving in directions along a conveyance direction of the medium.

According to the present configuration, since the contact member is configured to move in the directions along the conveyance direction of the medium, an increase in size of the liquid ejection head in directions intersecting the head surface can be suppressed compared to a configuration in which the contact member moves in the intersecting directions.

Note that the present configuration may be dependent from not only the second configuration but also the first configuration.

In a sixth configuration according to the fifth configuration, the displacement mechanism includes a support member that supports the contact member and moves in the directions along the conveyance direction of the medium to switch the contact member between the first position and the second position, a pressing member that presses the contact member toward the second position, and a cam member provided independently of the liquid ejection head, and configured to engage with the support member when the liquid ejection head is at the recording position and to be separated from the support member when the liquid ejection head is at the retracted position, wherein when the liquid ejection head is at the recording position, the cam member holds the contact member at the first position against a pressing force of the pressing member, when the liquid ejection head is displaced from the recording position to the retracted position, the support member is separated from the cam member, and the contact member is displaced from the first position to the second position by the pressing force of the pressing member, and when the liquid ejection head is displaced from the retracted position to the recording position, the cam member presses the support member against the pressing force of the pressing member, and the contact member is displaced from the second position to the first position.

According to the present configuration, the contact member can be displaced in conjunction with the displacement movement of the liquid ejection head with the simple configuration including the support member, the pressing member, and the cam member.

Note that the present configuration may be dependent from not only the fifth configuration but also the second configuration.

A seventh configuration according to the first configuration includes a plurality of the contact members when viewed from a width direction intersecting a conveyance direction of the medium, wherein the plurality of contact members include a first contact member and a second contact member located downstream of the first contact member in the conveyance direction.

According to the present configuration, since the plurality of contact members are provided when viewed from the width direction intersecting the conveyance direction, and the plurality of contact members include the first contact member and the second contact member located downstream of the first contact member in the conveyance direction, the contact of the medium with the head surface can be suitably suppressed.

The present configuration may be dependent from not only the first configuration but also any one of the second to sixth configurations.

In an eighth configuration according to the first configuration, the liquid ejection head includes a plurality of head chips having the nozzles on the head surface, the plurality of head chips are alternately disposed at an upstream position and a downstream position in a conveyance direction of the medium along a width direction intersecting the conveyance direction, a recess portion for avoiding the head chips is provided on at least one of an upstream side and a downstream side in the conveyance direction on the head surface, and the contact member enters the recess portion when the contact member is at the first position.

According to the present configuration, since the head surface is provided with the recess portion for avoiding the head chips on at least one of the upstream side and the downstream side in the conveyance direction, and the contact member enters the recess portion when the contact member is at the first position, the contact member can be brought close to the center position of the head surface in the conveyance direction. As a result, the contact of the medium with the head surface can be suitably suppressed.

The present configuration may be dependent from not only the first configuration but also any one of the second to seventh configurations.

In a ninth configuration according to the first configuration, the liquid ejection head is a line head including the nozzles along a width direction intersecting a conveyance direction of the medium, and the wiper wipes the head surface by moving from one end to the other end of the liquid ejection head in the width direction and further moving to a position away from the head surface.

According to the present configuration, since the wiper wipes the head surface by moving from one end to the other end of the liquid ejection head in the width direction and further moving to a position away from the head surface, the liquid attached to the wiper can be prevented from remaining on the head surface.

The present configuration may be dependent from not only the first configuration but also any one of the second to eighth configurations.

In a tenth configuration according to any one of the first to ninth configurations, the contact member is a roller that is rotatable in contact with the medium and is a toothed roller having teeth on an outer periphery.

According to the present configuration, since the contact member is the roller that is rotatable in contact with the medium and is the toothed roller having teeth on the outer periphery, reattachment to the medium of the liquid attached to the contact member can be suppressed.

An eleventh configuration according to the tenth configuration includes a cleaning member that cleans the contact member at a position where the cleaning member is allowed to come into contact with the contact member.

According to the present configuration, since the cleaning member that cleans the contact member is provided at the position where the cleaning member is allowed to come into contact with the contact member, reattachment to the medium of the liquid attached to the contact member can be further suppressed.

The present disclosure will specifically be described below.

An inkjet printer 1 will be described as an example of a recording apparatus that performs recording on a medium. Hereinafter, the inkjet printer 1 is simply referred to as a printer 1.

In an X-Y-Z coordinate system illustrated in the drawings, an X-axis direction is an apparatus width direction and is a width direction of a medium on which recording is performed. When viewed from an operator of the printer 1, the +X direction is the left side, and the −X direction is the right side. Hereinafter, the X-axis direction may be referred to as a medium width direction or simply a width direction.

A Y-axis direction is an apparatus depth direction and is a direction along a medium conveyance direction at recording. The +Y direction is a direction from the rear to the front of the apparatus, and the −Y direction is a direction from the front to the rear of the apparatus. In the present embodiment, among side surfaces forming the periphery of the printer 1, the side surface in the +Y direction is an apparatus front surface and the side surface in the −Y direction is an apparatus rear surface.

A Z-axis direction is a direction along the vertical direction and is an apparatus height direction. The +Z direction is the vertically upward direction and the −Z direction is the vertically downward direction.

Hereinafter, a direction in which the medium is transported may be referred to as “downstream” and the opposite direction thereto may be referred as “upstream”.

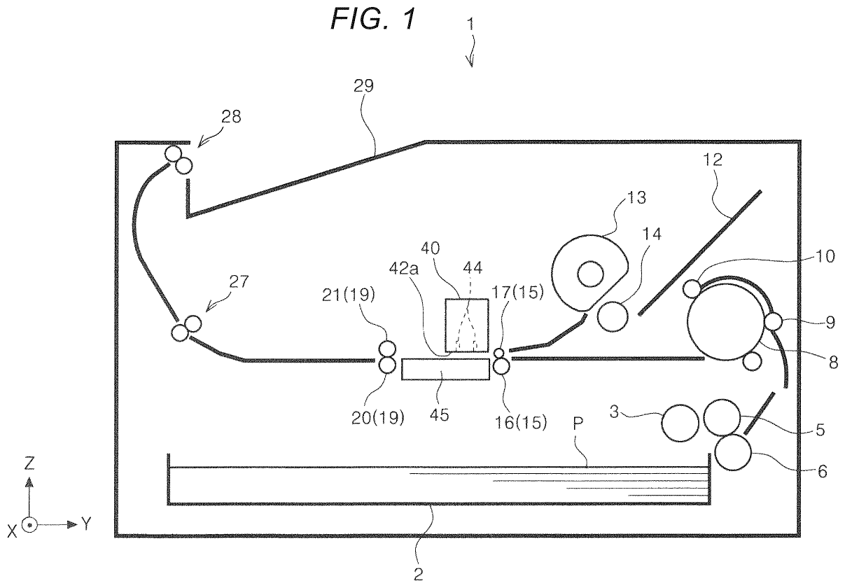

A medium conveyance path of the printer 1 will be explained with reference to FIG. 1. As illustrated in FIG. 1, the printer 1 includes a medium storage cassette 2 at the bottom of the apparatus. Sign P denotes a medium stored in the medium storage cassette 2. An example of the medium is a recording sheet. The medium storage cassette 2 is provided to be detachable from the apparatus front side.

A pick roller 3 driven by a motor (not illustrated) is provided above the medium storage cassette 2. The pick roller 3 can move close to and retract from the medium stored in the medium storage cassette 2 and rotates in contact with the medium stored in the medium storage cassette 2 to feed the medium from the medium storage cassette 2 in the +Y direction.

A feed roller 5 driven by a motor (not illustrated) and a separation roller 6 to which rotational torque is applied by a torque limiter (not illustrated) are provided downstream of the medium storage cassette 2. The medium fed from the medium storage cassette 2 is nipped and separated by the feed roller 5 and the separation roller 6 and is further fed downstream.

A reverse roller 8 driven by a motor (not illustrated) is provided downstream of the feed roller 5 and the separation roller 6. A first nip roller 9 and a second nip roller 10 are provided around the reverse roller 8, and the medium is nipped by the reverse roller 8 and the first nip roller 9 and further nipped by the reverse roller 8 and the second nip roller 10 and conveyed. The conveyance direction of the medium is reversed from the +Y direction to the −Y direction by the reverse roller 8, and the medium is conveyed downstream.

A first conveyance roller pair 15 including a driving roller 16 driven by a motor (not illustrated) and a driven roller 17 that can be driven to rotate is provided downstream of the reverse roller 8. The medium is conveyed to a position facing a line head 40 by the first conveyance roller pair 15.

The printer 1 includes a medium feeding path from a medium support portion 12 in addition to a medium feeding path from the medium storage cassette 2. The medium support portion 12 supports the medium in an inclined attitude, and the supported medium is conveyed to the first conveyance roller pair 15 by a feed roller 13 driven by a motor (not illustrated). Sign 14 denotes a separation roller to which rotational torque is applied by a torque limiter (not illustrated).

The line head 40 is an example of a liquid ejection head that ejects ink, which is an example of a liquid, onto a medium to perform recording. The line head 40 is a liquid ejection head in which a plurality of nozzles 44 for ejecting ink are arranged to cover the entire region in the medium width direction. The line head 40 is elongated in the medium width direction and is configured as a liquid ejection head that can perform recording on the entire medium width region without moving in the medium width direction.

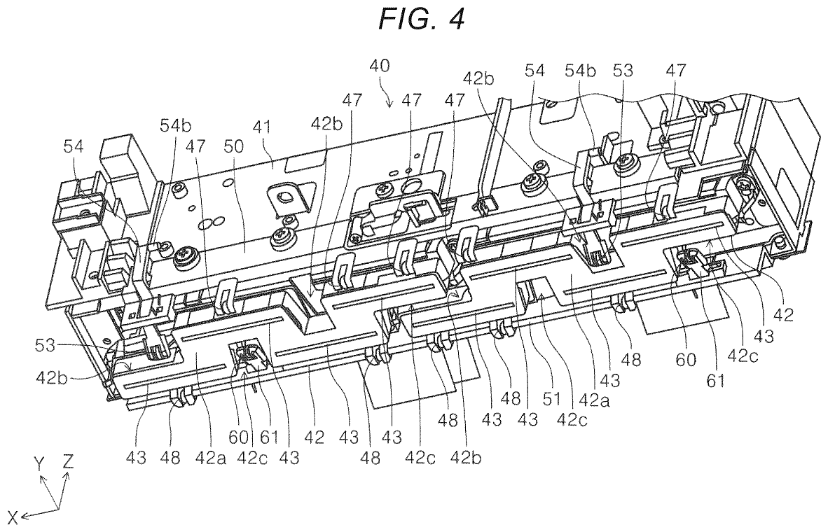

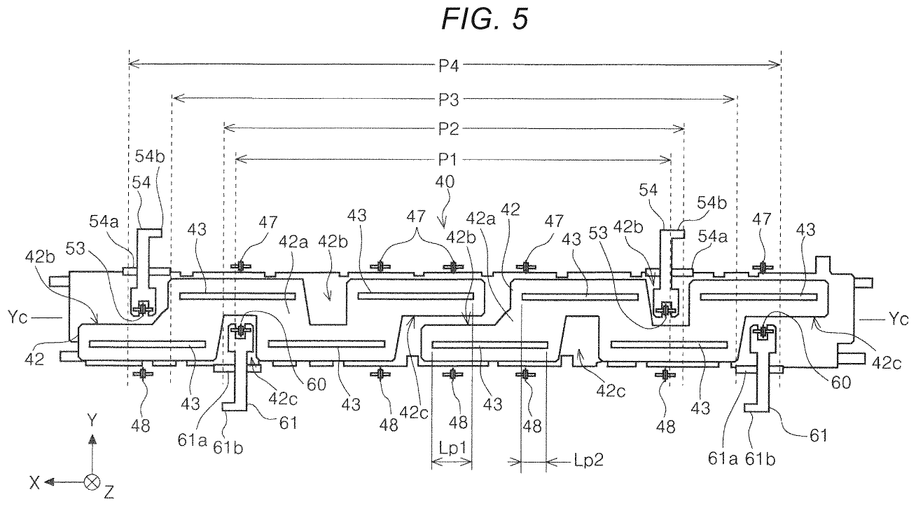

Sign 42a denotes a head surface to face the medium. The head surface 42a may also be referred to as a liquid ejection surface or a nozzle surface. The head surface 42a is formed with a plate member 42 (see FIGS. 4 and 5) described later. The head surface 42a is parallel to the medium conveyance direction, that is, the Y-axis direction at a position facing the line head 40.

The printer 1 includes an ink storage portion (not illustrated), and the ink ejected from the line head 40 is supplied from the ink storage portion to the line head 40 via an ink tube (not illustrated).

A facing portion 45 is provided at a position facing the head surface 42a of the line head 40, and a gap between the medium and the head surface 42a is defined by supporting the medium by the facing portion 45. Hereinafter, the gap between the facing portion 45 and the head surface 42a may be referred to as a platen gap.

A second conveyance roller pair 19 including a driving roller 20 driven by a motor (not illustrated) and a driven roller 21 that can be driven to rotate is provided downstream of the line head 40. The medium on which the recording has been performed is conveyed downstream by the second conveyance roller pair 19.

A third conveyance roller pair 27 is provided downstream of the second conveyance roller pair 19, and an ejection roller pair 28 is provided downstream of the third conveyance roller pair 27. A path between the third conveyance roller pair 27 and the ejection roller pair 28 is configured as a face-down ejection path, and the medium on which recording has been performed is ejected to an ejection tray 29 by the ejection roller pair 28 with the latest recorded surface facing down.

Next, an elevating operation of the line head 40 will be described.

The line head 40 is movable in a direction in which the line head 40 moves close to and retract from the facing portion 45, that is, in an adjustment direction of the platen gap. In the present embodiment, the adjustment direction of the platen gap is parallel to the Z-axis direction. Hereinafter, the movement of the line head 40 in the +Z-axis direction may be referred to as “rise” and the movement in the −Z direction may be referred to as “fall”.

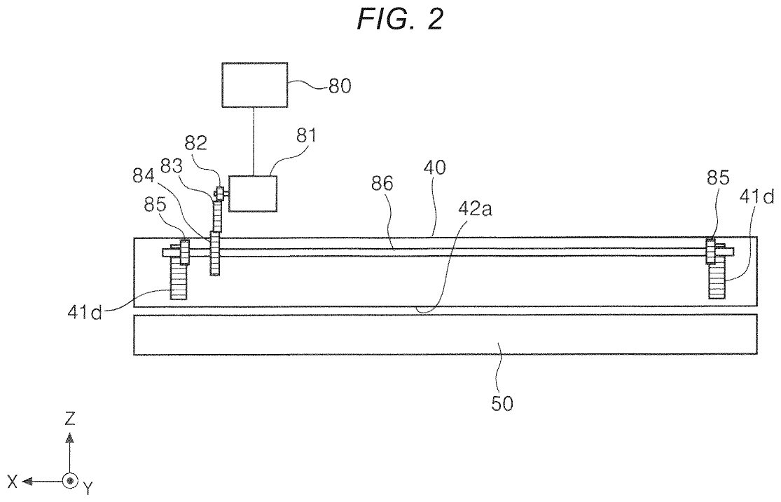

FIG. 2 illustrates an adjustment mechanism for the platen gap, Sign 81 denotes a head movement motor as a drive source for moving up and down the line head 40, and Sign 80 denotes a control portion that controls the head movement motor 81. The control portion 80 is a control portion that controls the entire printer 1.

A motor gear 82 is provided on a motor shaft of the head movement motor 81, and the motor gear 82 transmits a driving force to a pinion gear 85 via a gear 83 and a gear 84. The gear 84 and the pinion gear 85 are fixed to a shaft 86.

The line head 40 is held by a guide member (not illustrated) so as to be displaceable in the Z-axis direction. A rack portion 41d is formed in the line head 40 along the Z-axis direction, and the pinion gear 85 meshes with the rack portion 41d to form a rack and pinion mechanism.

The pinion gear 85 rotates by the rotation of the head moving motor 81, whereby the line head 40 is moved up and down.

The rack and pinion mechanism including the rack portion 41d and the pinion gear 85 is provided near both end portions in the medium width direction with respect to the line head 40.

When rising, the line head 40 comes into contact with a rise restriction portion (not illustrated), and a further rise is restricted. The control portion 80 can grasp that the line head 40 is located at a rise limit position by detecting an increase in the motor drive current value when the line head 40 comes into contact with the rise restriction portion.

Further, an encoder sensor (not illustrated) is provided in the head movement motor 81, and the control portion 80 can detect the amount of rotation of the head movement motor 81. Accordingly, the control portion 80 can detect the amount of movement of the line head 40 from the rise limit position, that is, can grasp the current position of the line head 40.

The control portion 80 moves up and down the line head 40 according to the thickness of the medium based on the medium type contained in the received print data, and adjusts the platen gap. For example, with the position of the line head 40 when recording is performed on plain paper as a first recording position, when recording is performed on exclusive paper thicker than plain paper, the line head 40 is positioned at a second recording position higher than the first recording position.

In addition to the plurality of recording positions as described above, the movement region of the line head 40 includes a cap position which is a position when the line head 40 is capped by a cap portion (not illustrated) and a retracted position which is a position when the head surface 42a is wiped by a wiper 36, which will be described later.

In the present embodiment, the above-described positions of the line head 40 are the cap position, the first recording position, the second recording position, and the retracted position in order toward the +Z direction.

Next, the wiper 36 will be described.

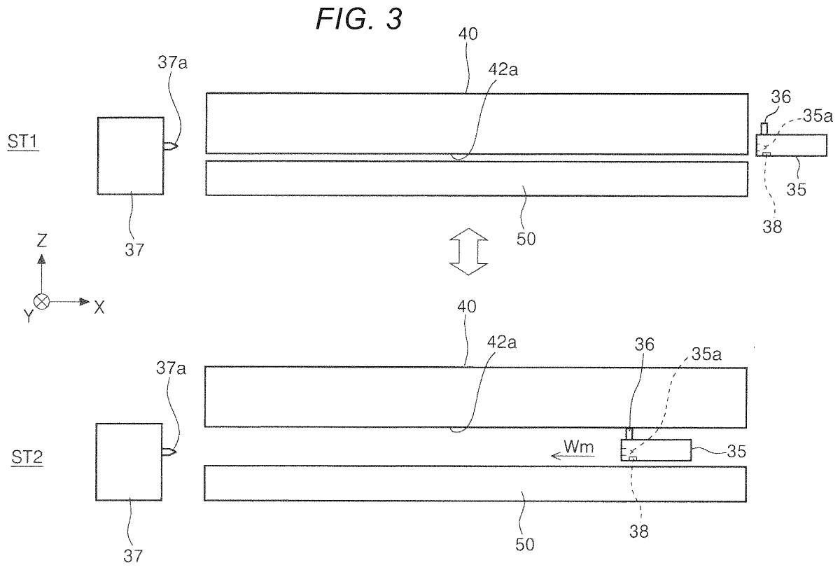

As illustrated in FIG. 3, the printer 1 includes a wiper carriage 35 that moves in the X-axis direction by a motor (not illustrated). In the present embodiment, the wiper carriage 35 has a home position at the position in FIG. 3, that is, the end position in the +X direction.

The wiper carriage 35 is formed in a box shape whose upper portion is open, and provided with the wiper 36. The wiper 36 is made of an elastic material such as rubber, and particularly wipes a head chip 43 (see FIGS. 4 and 5), which will be described later, of the head surface 42a by the wiper carriage 35 moving in the medium width direction in elastic contact with the head surface 42a. The ink removed by the wiping is accumulated in the wiper carriage 35.

A fitting hole 35a is provided in the end portion of the wiper carriage 35 in the −X direction. A check valve (not illustrated) is provided in the fitting hole 35a, and the ink accumulated in the wiper carriage 35 is not leaked by the check valve.

An ink collection portion 37 is provided in the end portion in the −X direction in the movement region of the wiper carriage 35. The ink collecting portion 37 has a suction portion 37a, and the suction portion 37a can be fitted into the fitting hole 35a of the wiper carriage 35. When the wiper carriage 35 moves to the end portion in the −X direction, the suction portion 37a is fitted into the fitting hole 35a. When the suction portion 37a is fitted into the fitting hole 35a, the check valve is opened. In this state, a pump (not illustrated) provided in the ink collection portion 37 is driven, thereby suctioning the ink stored in the wiper carriage 35.

A state ST1 in FIG. 3 shows a state in which the line head 40 is at the recording position. From the state, for wiping the head surface 42a by the wiper 36, the line head 40 is raised to the retracted position as illustrated by the change from the state ST1 to a state ST2 in FIG. 3. Accordingly, a gap for the wiper carriage 35 to enter is formed between the line head 40 and the facing portion 45, and the wiper 36 can come into contact with the head surface 42a.

In this state, by moving the wiper carriage 35 as indicated by an arrow Wm, the wiper 36 wipes the head surface 42a.

After the wiper 36 moves to the end portion in the −X direction, that is, after the wiper 36 wipes the head surface 42a, the wiper carriage 35 moves in the +X direction to return to the home position in the end portion in the +X direction. Prior to the movement, the line head 40 may be slightly raised to prevent the wiper 36 from coming into contact with the head surface 42a.

As described above, since the wiper 36 wipes the head surface 42a by moving from one end to the other end of the line head 40 in the medium width direction and further moving to the position away from the head surface 42a, the ink attached to the wiper 36 can be prevented from remaining on the head surface 42a.

Next, the line head 40 and contact members will be described with reference to FIG. 4 and the subsequent drawings.

As illustrated in FIG. 4, the line head 40 includes plate members 42 on a base 41. The base 41 is a structure in which flow paths for supplying ink supplied from an ink container portion (not illustrated) to head chips 43 are provided.

The plate member 42 is a metal plate and forms the head surface 42a.

The plate member 42 is provided with a plurality of the head chips 43. The head chip 43 is provided with a plurality of nozzles 44 (see FIG. 1) along the medium width direction. The plate member 42 and the head chips 43 are provided so as to be flush with each other.

In the present embodiment, the line head 40 includes the two plate members 42 along the medium width direction. In one plate member 42, the head chips 43 are alternately disposed at upstream positions and downstream positions along the X-axis direction, that is, the medium width direction. In one plate member 42, the two head chips 43 at the upstream position are provided along the medium width direction, and the two head chips 43 at the downstream position are provided along the medium width direction. Accordingly, in the line head 40, the four head chips 43 at the upstream position are provided along the medium width direction, and the four head chips 43 at the downstream position are provided along the medium width direction.

The plurality of head chips 43 are provided so as to overlap each other along the medium width direction. In FIG. 5, Sign Lp2 denotes an overlap amount when the two head chips 43 among the four head chips 43 provided on one plate member 42 overlap each other. In the present embodiment, the overlap amount when the two head chips 43 among the four head chips 43 provided on one plate member 42 overlap is Lp2 and is constant.

However, in the present embodiment, an overlap amount Lp1 when the head chips 43 provided on the different plate members 42 overlap is different from Lp2. The overlap amount Lp1 is an overlap amount when the two plate members 42 provided along the medium width direction overlap each other in the medium width direction, thereby overlapping the two head chips 43. In the present embodiment, the overlap amount Lp1 is larger than the overlap amount Lp2. However, the overlap amount Lp1 may be the same as or smaller than the overlap amount Lp2.

Further, the line head 40 has upstream recess portions 42b and downstream recess portions 42c on the head surface 42a. The upstream recess portions 42b and the downstream recess portions 42c are formed as spaces having a predetermined height in the +Z direction from the head surface 42a.

In the present embodiment, the two upstream recess portions 42b are provided upstream in the medium conveyance direction with respect to one plate member 42. In one plate member 42, one upstream recess portion 42b is provided between the two head chips 43 adjacent to each other in the medium width direction. Further, in one plate member 42, the other upstream recess portion 42b is provided in the +X direction with respect to the head chip 43 located in the +X direction among the two head chips 43.

Similarly, in the present embodiment, the two downstream recess portions 42c are provided downstream in the medium conveyance direction with respect to one plate member 42. In one plate member 42, one downstream recess portion 42c is provided between the two head chips 43 adjacent to each other in the medium width direction. Further, in one plate member 42, the other one downstream recess portion 42c is provided in the −X direction with respect to the head chip 43 located in the −X direction among the two head chips 43.

Next, the contact members provided integrally with the line head 40 will be described.

The leading end and the trailing end of the medium passing between the line head 40 and the facing portion 45 may rise due to curling particularly in the end portions in the medium width direction, and the medium may come into contact with the head surface 42a and be contaminated. Therefore, it is preferable that the line head 40 is provided with contact members that come into contact with the medium to suppress contact of the medium with the head surface 42a.

In the present embodiment, upstream fixed rollers 47, downstream fixed rollers 48, upstream movable rollers 53, and downstream movable rollers 60 are provided as the contact members. All of these rollers are toothed rollers having teeth on the outer circumferences, and thus reattachment to the medium of the ink attached to the rollers can be suppressed.

Hereinafter, the term “contact members” refer to the upstream movable rollers 53 and the downstream movable rollers 60.

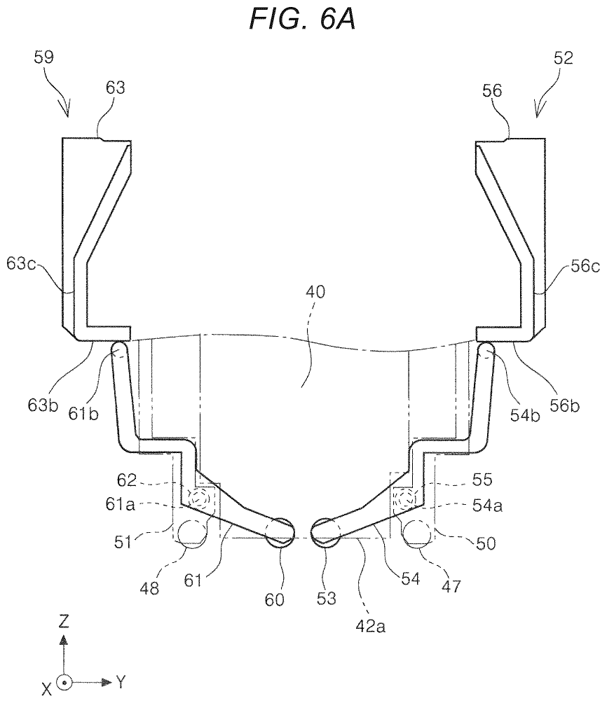

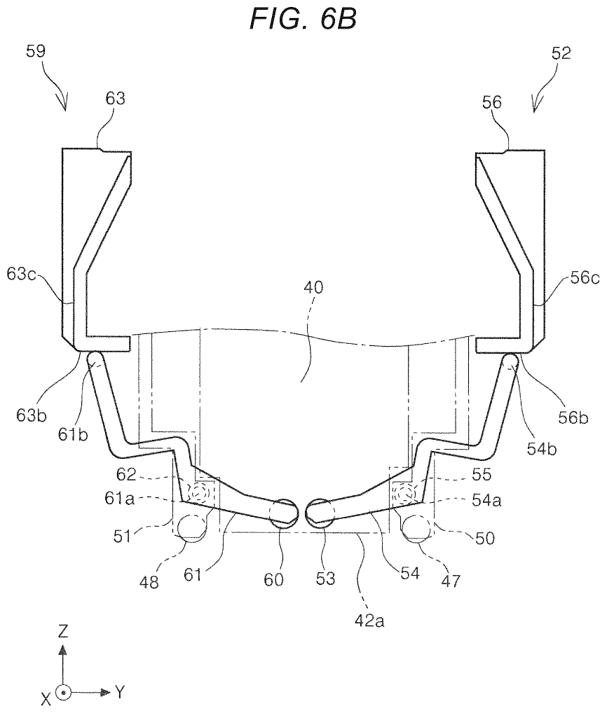

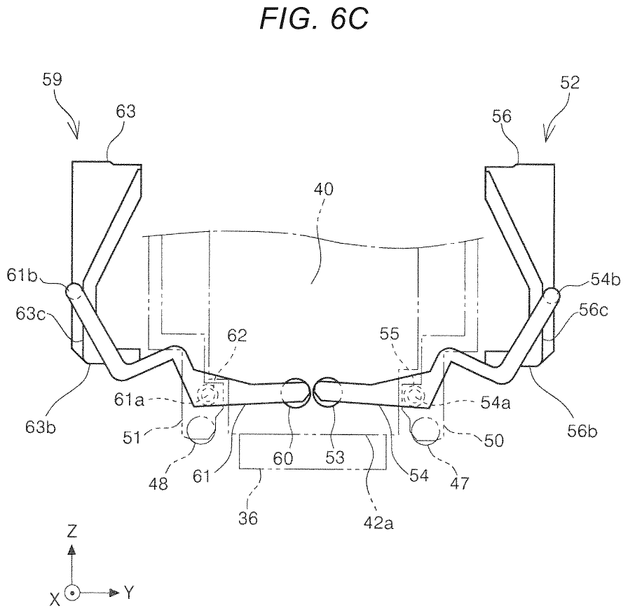

The upstream fixed rollers 47 and the downstream fixed rollers 48 protrude from the head surface 42a in the −Z direction, that is, toward the facing portion 45, as illustrated in FIGS. 6A to 6C, regardless of the position of the line head 40. Accordingly, the upstream fixed rollers 47 and the downstream fixed rollers 48 suppress contact of the medium with the head surface 42a.

As illustrated in FIG. 4, the line head 40 includes an upstream frame 50 on a side surface in the +Y direction, that is, at the upstream side in the medium conveyance direction, and includes a downstream frame 51 on a side surface in the −Y direction, that is, at the downstream side in the medium conveyance direction.

The upstream fixed rollers 47 are rotatably supported by the upstream frame 50. A plurality of the upstream fixed rollers 47 are provided along the medium width direction in the upstream frame 50. As illustrated in FIG. 5, the upstream fixed rollers 47 are located in the +Y direction, that is, upstream of the plate member 42 in the medium conveyance direction.

In FIG. 5, the upstream frame 50 and the downstream frame 51 are omitted for convenience of illustration.

As illustrated in FIG. 4, the downstream fixed rollers 48 are rotatably supported by the downstream frame 51. A plurality of the downstream fixed rollers 48 are provided along the medium width direction in the downstream frame 51. As illustrated in FIG. 5, the downstream fixed rollers 48 are located in the −Y direction, that is, downstream of the plate member 42 in the medium conveyance direction.

Further, the upstream movable rollers 53 and the downstream movable rollers 60 as the contact members can be displaced to first positions and second positions which are relative positions to the head surface 42a. FIG. 6A shows the first position of the contact members. The first position is a position where the contact members are allowed to interfere with the wiper 36 and come into contact with the medium. In other words, the first position of the contact members is a position inside the movement trajectory of the wiper 36 that wipes the head surface 42a, where the contact members are allowed to come into contact with the medium. In the present embodiment, the first position of the contact members is a position where the contact members protrude from the head surface 42a in the −Z direction.

The second position of the contact members is a position where the contact members are not allowed to interfere with the wiper 36. Specifically, the second position of the contact members is a position where the contact members are retracted from the head surface 42a in the +Z direction. FIG. 6C shows the second position of the contact members.

As described above, the contact members are set at the first position, and thus the contact of the medium with the head surface 42a can be suppressed. Further, the contact members are set at the second position, and thus the contact members can be prevented from becoming obstacles to wiping of the head surface 42a by the wiper 36. Therefore, it is not necessary to dispose a plurality of the wipers 36 so as to avoid the contact members, and an increase in cost of the apparatus can be suppressed. In addition, for replacement of the wiper 36, a significant increase in the man-hour for work and the component cost can be suppressed.

Next, displacement mechanisms that displace the contact members between the first position and the second position will be described mainly with reference to FIGS. 6A to 6C. In FIGS. 6A to 6C, for convenience of illustration, the configurations of an upstream displacement mechanism 52 and a downstream displacement mechanism 59 are mainly indicated by solid lines, and the other configurations are indicated by two-dot chain lines.

In the present embodiment, the upstream displacement mechanism 52 that displaces the upstream movable roller 53 and the downstream displacement mechanism 59 that displaces the downstream movable roller 60 are provided as the displacement mechanisms that displace the contact members between the first position and the second position.

The basic configurations of the upstream displacement mechanism 52 and the downstream displacement mechanism 59 are the same, and the upstream displacement mechanism 52 and the downstream displacement mechanism 59 form a symmetrical structure when viewed from the medium width direction as illustrated in FIGS. 6A to 6C.

The upstream displacement mechanism 52 includes an upstream support member 54 and an upstream cam member 56. The upstream support member 54 is a member that rotatably supports the upstream movable roller 53, and can change its attitude between a first pivot attitude (FIG. 6A) in which the upstream movable roller 53 is in the first position and a second pivot attitude (FIG. 6C) in which the upstream movable roller 53 is in the second position by pivoting around a pivot shaft 54a. In the present embodiment, the axial center line of the pivot shaft 54a is parallel to the X-axis direction. The pivot shaft 54a is supported by the upstream frame 50 (see FIG. 4).

The upstream support member 54 is pressed by a coil spring 55 as a pressing member in the counterclockwise direction in FIGS. 6A to 6C, that is, in a direction in which the upstream movable roller 53 moves toward the first position. The pressing force of the coil spring 55 may be adjusted, and the upstream movable roller 53 may be retracted when the upstream movable roller 53 comes into contact with a medium having higher stiffness such as thick paper. Accordingly, contact of a medium having lower stiffness with the head surface 42a can be suppressed, and occurrence of jam or damage of the medium due to contact of a medium having higher stiffness with the upstream movable roller 53 can be suppressed.

When the upstream support member 54 can return from the second pivot attitude to the first pivot attitude by its own weight, the coil spring 55 may be omitted.

The upstream support member 54 includes a cam follower portion 54b as a portion engageable with the upstream cam member 56.

The upstream cam member 56 is a member provided independently of the line head 40 and is engageable with the upstream support member 54. The upstream cam member 56 is provided on a frame (not illustrated). The upstream support member 54 is movable relative to the upstream cam member 56 in the Z-axis direction as the line head 40 moves up and down.

The upstream cam member 56 has a horizontal cam surface 56b along the X-Y plane and a vertical cam surface 56c along the X-Z plane.

The downstream displacement mechanism 59 includes a downstream support member 61 and a downstream cam member 63. The downstream support member 61 is a member that rotatably supports the downstream movable roller 60, and can change its attitude between a first pivot attitude (FIG. 6A) in which the downstream movable roller 60 is in the first position and a second pivot attitude (FIG. 6C) in which the downstream movable roller 60 is in the second position by pivoting around a pivot shaft 61a. In the present embodiment, the axial center line of the pivot shaft 61a is parallel to the X-axis direction. The pivot shaft 61a is supported by the downstream frame 51 (see FIG. 4).

The downstream support member 61 is pressed by a coil spring 62 as a pressing member in the clockwise direction in FIGS. 6A to 6C, that is, in a direction in which the downstream movable roller 60 moves toward the first position.

The pressing force of the coil spring 62 may be adjusted, and the downstream movable roller 60 may be retracted when the downstream movable roller 60 comes into contact with a medium having higher stiffness such as thick paper. Accordingly, contact of a medium having lower stiffness with the head surface 42a can be suppressed, and occurrence of jam or damage of the medium due to contact of a medium having higher stiffness with the downstream movable roller 60 can be suppressed.

When the downstream support member 61 can return from the second pivot attitude to the first pivot attitude by its own weight, the coil spring 62 may be omitted.

The downstream support member 61 includes a cam follower portion 61b as a portion engageable with the downstream cam member 63.

The downstream cam member 63 is a member provided independently of the line head 40 and is engageable with the downstream support member 61. The downstream cam member 63 is provided on a frame (not illustrated). The downstream support member 61 is movable relative to the downstream cam member 63 in the Z-axis direction as the line head 40 moves up and down.

The downstream cam member 63 has a horizontal cam surface 63b along the X-Y plane and a vertical cam surface 63c along the X-Z plane.

FIG. 6A illustrates a state in which the line head 40 is in the recording position, the contact members, that is, the upstream movable roller 53 and the downstream movable roller 60 are in the first position, and the upstream support member 54 and the downstream support member 61 are in the first pivot attitude. From the state, for wiping the head surface 42a by the wiper 36 (see FIG. 3), the line head 40 rises toward the retracted position. With the rise of the line head 40, as shown in the change from FIG. 6A to FIG. 6B, the horizontal cam surface 56b guides the upstream support member 54 toward the second pivot attitude, and the horizontal cam surface 63b guides the downstream support member 61 toward the second pivot attitude.

When the line head 40 further rises, as illustrated in FIG. 6C, the cam follower portion 54b of the upstream support member 54 shifts from the horizontal cam surface 56b to the vertical cam surface 56c, and the line head 40 rises with the second pivot attitude of the upstream support member 54 kept.

Similarly, the cam follower portion 61b of the downstream support member 61 shifts from the horizontal cam surface 63b to the vertical cam surface 63c, and the line head 40 rises with the second pivot attitude of the downstream support member 61 kept.

When the line head 40 moves to the retracted position shown in FIG. 6C, the upstream movable roller 53 and the downstream movable roller 60 are retracted from the head surface 42a, and thus the head surface 42a can be wiped by the wiper 36.

As described above, since the upstream cam member 56 has the vertical cam surface 56c for keeping the attitude of the upstream support member 54 in addition to the horizontal cam surface 56b for changing the attitude of the upstream support member 54, the amount of pivot of the upstream support member 54 can be minimized. That is, since the amount of rise of the upstream movable roller 53 can be minimized, a space for receiving the upstream movable roller 53 in the line head 40 can be minimized, and an increase in size of the line head 40 can be suppressed.

Similarly, since the downstream cam member 63 has the vertical cam surface 63c for keeping the attitude of the downstream support member 61 in addition to the horizontal cam surface 63b for changing the attitude of the downstream support member 61, the amount of pivot of the downstream support member 61 can be minimized. That is, since the amount of rise of the downstream movable roller 60 can be minimized, a space for receiving the downstream movable roller 60 in the line head 40 can be minimized, and an increase in size of the line head 40 can be suppressed.

When the line head 40 falls toward the recording position from the state in FIG. 6C, a state change opposite to the above-described state change occurs, the upstream cam member 56 guides the upstream support member 54 from the second pivot attitude to the first pivot attitude, and the downstream cam member 63 guides the downstream support member 61 from the second pivot attitude to the first pivot attitude. As a result, the upstream movable roller 53 and the downstream movable roller 60 are displaced from the second position to the first position.

As described above, the contact members can be displaced in conjunction with the displacement movement of the line head 40 with the simple configuration including the upstream support member 54 and the upstream cam member 56, and the downstream support member 61 and the downstream cam member 63.

Further, as described above, the displacement mechanisms that displaces the contact members, that is, the upstream displacement mechanism 52 and the downstream displacement mechanism 59, converts the displacement movement of the line head 40 into the displacement movement of the contact members, when the line head 40 is displaced from the recording position to the retracted position, displaces the contact members from the first position to the second position, and when the line head 40 is displaced from the retracted position to the recording position, displaces the contact members from the second position to the first position. This eliminates the need for a power source for displacing the contact members, and thus an increase in cost of the apparatus can be suppressed.

In the present embodiment, the contact members are displaced to the first position and the second position by moving in the directions intersecting the head surface 42a. Accordingly, an increase in size of the line head 40 in the medium conveyance direction can be suppressed compared to a configuration in which the contact members move along the medium conveyance direction.

Here, returning to FIG. 5, the positional relationship between the medium size and the respective rollers is described.

In FIG. 5, a range P1 is a range through which a medium of a minimum size assumed to be used passes, and corresponds to, for example, a lateral dimension (about 140 mm) of a half-letter size medium. A range P2 corresponds to a lateral dimension (148 mm) of an A5 size medium. A range P3 corresponds to a lateral dimension (182 mm) of a B5 size medium. A range P4 corresponds to a lateral dimension (about 210 mm) of an A4 size medium.

In the media corresponding to the ranges P1, P2, and P3, the contact of the end portion in the +X direction with the head surface 42a is suppressed by the upstream fixed roller 47 and the downstream movable roller 60, and the contact of the end portion in the −X direction with the head surface 42a is suppressed by the upstream movable roller 53 and the downstream fixed roller 48.

In the medium corresponding to the range P4 or a medium having a size larger than the range P4, the contact of the end portion in the +X direction with the head surface 42a is suppressed by the upstream movable roller 53 and the downstream fixed roller 48, and the contact of the end portion in the −X direction with the head surface 42a is suppressed by the upstream fixed roller 47 and the downstream movable roller 60.

Both the upstream movable roller 53 and the downstream movable roller 60 are disposed at positions close to a center position Yc of the head surface 42a in the medium conveyance direction. This is because the upstream movable roller 53 enters the upstream recess portion 42b, and the downstream movable roller 60 enters the downstream recess portion 42c.

Accordingly, in the present embodiment, both the upstream movable roller 53 and the downstream movable roller 60 are located between the upstream head chip 43 and the downstream head chip 43 in the medium conveyance direction.

Therefore, the contact of the end portions of the medium in the medium width direction with the head surface 42a can be suitably suppressed.

In the present embodiment, the downstream fixed roller 48 is disposed downstream of the upstream movable roller 53, and the upstream fixed roller 47 is disposed upstream of the downstream movable roller 60. Further, the downstream fixed rollers 48 are disposed downstream of the three upstream fixed rollers 47 located in the center region in the medium width direction.

According to the above-described configuration, the contact of the media corresponding to the ranges P1, P2, and P3 with the head surface 42a is first suppressed by the upstream fixed roller 47 along with the conveyance, then the contact with the head surface 42a is suppressed by the upstream movable roller 53 located in the −X direction and the downstream movable roller 60 located in the +X direction, and then the contact with the head surface 42a is suppressed by the downstream fixed roller 48.

The contact of the medium corresponding to the range P4 with the head surface 42a is first suppressed by the upstream fixed rollers 47 along with the conveyance, then the contact with the head surface 42a is suppressed by the two upstream movable rollers 53 and the two downstream movable rollers 60, and then the contact with the head surface 42a is suppressed by the downstream fixed rollers 48.

According to the above-described configuration, the contact of the medium with the head surface 42a is suitably suppressed.

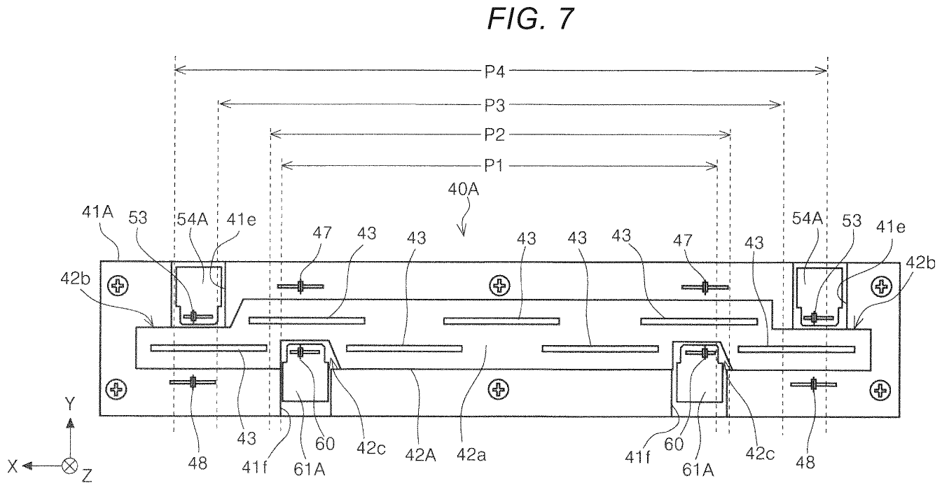

Next, another embodiment will be described with reference to FIG. 7 and the subsequent drawings. Hereinafter, the same configurations as those already described will have the same signs, and the overlapping description will be avoided. Further, hereinafter, in the modifications of the configurations already described, the numeral signs are distinguished by adding alphabet characters “A”.

In the embodiment described above, the upstream movable roller 53 and the downstream movable roller 60 are displaced in the directions intersecting the head surface 42a, but in the embodiment described below, the upstream movable roller 53 and the downstream movable roller 60 are displaced along the medium conveyance direction.

In the present embodiment, a line head 40A includes one plate member 42A. In the plate member 42A, the head chips 43 are alternately disposed at upstream positions and downstream positions along the X-axis direction, that is, the medium width direction. As illustrated in FIG. 7, in the plate member 42A, the three head chips 43 at the upstream positions are provided along the medium width direction, and the four head chips 43 at the downstream positions are provided along the medium width direction. The plurality of head chips 43 are provided so as to overlap each other along the medium width direction.

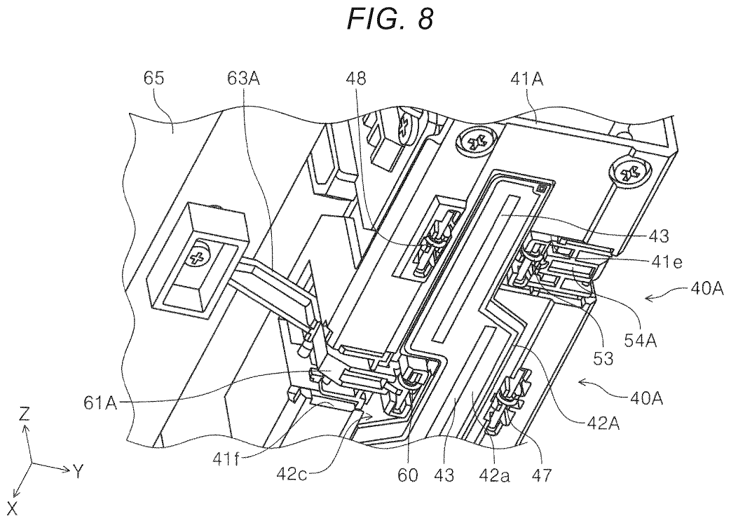

FIG. 7 shows a state in which the upstream movable roller 53 and the downstream movable roller 60 are at the first position. A base 41A of the line head 40 is provided with two upstream cutout portions 41e at an interval in the medium width direction at the upstream side. The upstream cutout portion 41e is formed at the position of the upstream recess portion 42b in the medium width direction (see also FIG. 8). Further, in the base 41A of the line head 40, two downstream cutout portions 41f are provided at an interval in the medium width direction at the downstream side. The downstream cutout portion 41f is formed at the position of the downstream recess portion 42c in the medium width direction (see also FIG. 8).

The upstream cutout portion 41e and the downstream cutout portion 41f are formed as spaces having a predetermined height in the +Z direction from the head surface 42a.

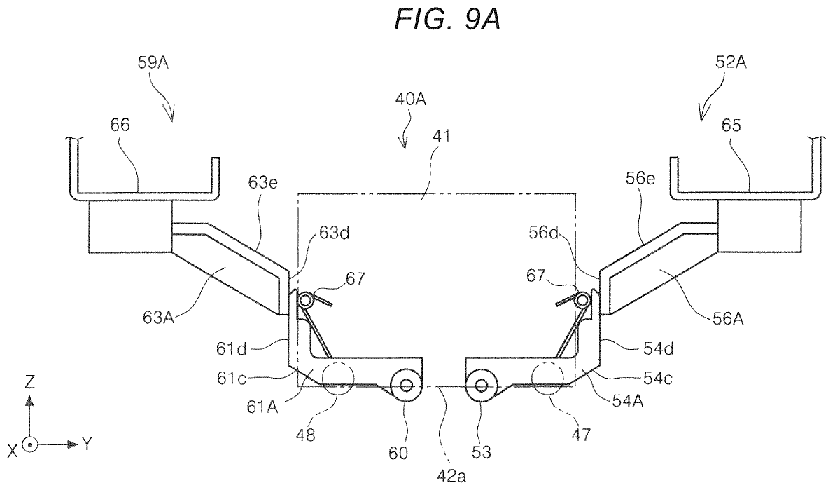

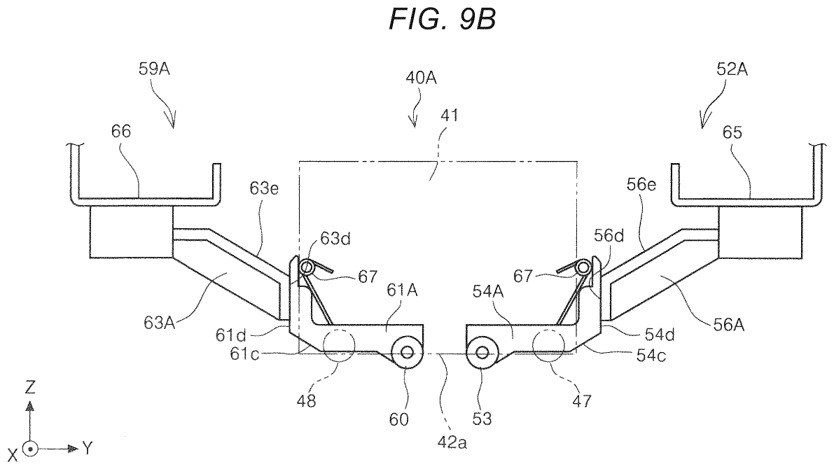

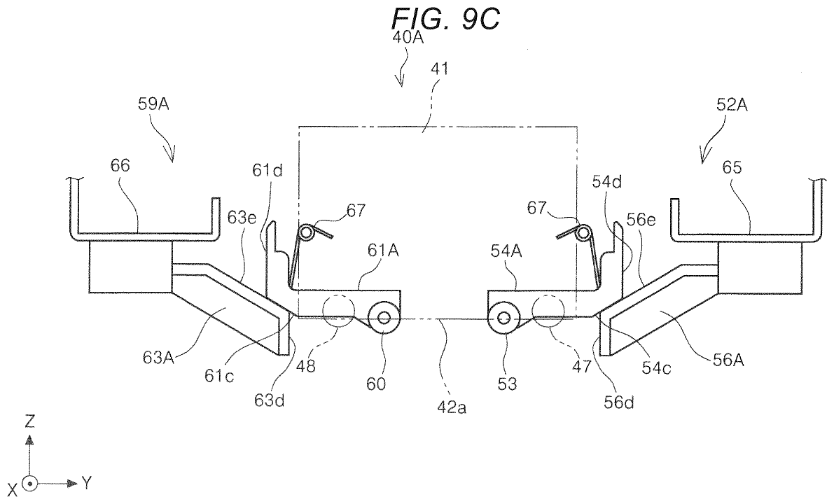

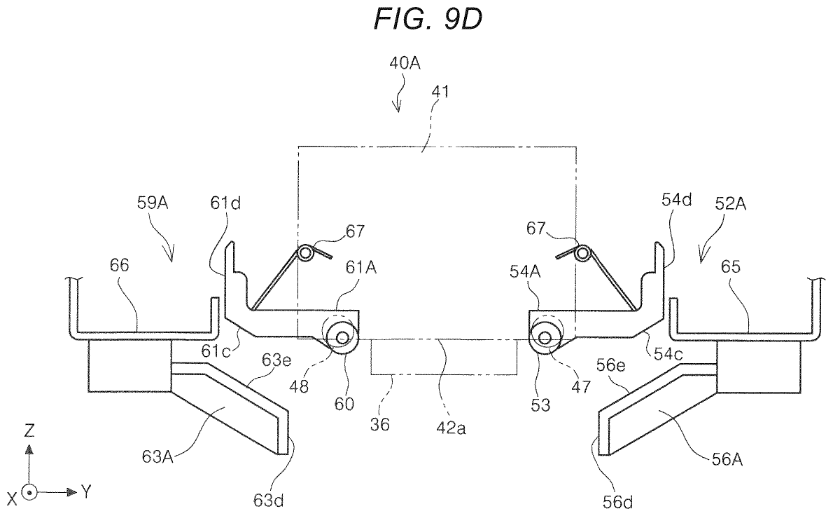

Next, displacement mechanisms that displace the contact members between a first position and a second position will be described mainly with reference to FIGS. 9A to 9D. In FIGS. 9A to 9D, for convenience of illustration, the configurations of an upstream displacement mechanism 52A and a downstream displacement mechanism 59A are mainly indicated by solid lines, and the other configurations are indicated by two-dot chain lines.

In the present embodiment, the upstream displacement mechanism 52A that displaces the upstream movable roller 53 and the downstream displacement mechanism 59A that displaces the downstream movable roller 60 are provided as displacement mechanisms that displace the contact members between the first position and the second position.

The basic configurations of the upstream displacement mechanism 52A and the downstream displacement mechanism 59A are the same, and the upstream displacement mechanism 52A and the downstream displacement mechanism 59A form a symmetrical structure when viewed from the medium width direction as illustrated in FIGS. 9A to 9D.

The upstream displacement mechanism 52A includes an upstream support member 54A and an upstream cam member 56A. The upstream support member 54A is a member that rotatably supports the upstream movable roller 53. The upstream support member 54A switches the upstream movable roller 53 between the first position (see FIGS. 9A and 9B) and the second position (see FIG. 9D) by moving along the medium conveyance direction.

Further, the upstream support member 54A is pressed by a coil spring 67 as a pressing member in the +Y direction, that is, in a direction in which the upstream movable roller 53 moves toward the second position.

Further, the upstream support member 54 includes an inclined surface 54c and a vertical surface 54d as portions engageable with the upstream cam member 56A.

The upstream cam member 56A is a member provided independently of the line head 40 and is engageable with the upstream support member 54A. The upstream cam member 56A is provided on an upstream support frame 65. The upstream support member 54A is movable relative to the upstream cam member 56A in the Z-axis direction as the line head 40 moves up and down.

The upstream cam member 56A includes a vertical cam surface 56d and an inclined cam surface 56e.

As will be described in detail later, the upstream cam member 56A is engageable with the upstream support member 54A when the line head 40 is at the recording position, and is separated from the upstream support member 54A when the line head 40 is at the retracted position. The downstream displacement mechanism 59A includes a downstream support member 61A and a downstream cam member 63A. The downstream support member 61A is a member that rotatably supports the downstream movable roller 60. The downstream support member 61A switches the downstream movable roller 60 between the first position (see FIGS. 9A and 9B) and the second position (see FIG. 9D) by moving along the medium conveyance direction.

Further, the downstream support member 61A is pressed by the coil spring 67 as a pressing member in the −Y direction, that is, in a direction in which the downstream movable roller 60 moves toward the second position.

Furthermore, the downstream support member 61 includes an inclined surface 61c and a vertical surface 61d as portions engageable with the downstream cam member 63A.

The downstream cam member 63A is a member provided independently of the line head 40 and is engageable with the downstream support member 61A. The downstream cam member 63A is provided on a downstream support frame 66. The downstream support member 61A is movable relative to the downstream cam member 63A in the Z-axis direction as the line head 40 moves up and down.

The downstream cam member 63A has a vertical cam surface 63d and an inclined cam surface 63e.

As will be described in detail later, the downstream cam member 63A is engageable with the downstream support member 61A when the line head 40 is at the recording position, and is separated from the downstream support member 61A when the line head 40 is at the retracted position.

FIG. 9A illustrates a state in which the line head 40 is at the recording position and the contact members, that is, the upstream movable roller 53 and the downstream movable roller 60 are at the first position. In this state, the upstream cam member 56A holds the upstream movable roller 53 at the first position against the pressing force of the coil spring 67, and the downstream cam member 63A holds the downstream movable roller 60 at the first position against the pressing force of the coil spring 67.

From the state, for wiping the head surface 42a by the wiper 36 (see FIG. 3), the line head 40 rises toward the retracted position. With the rise of the line head 40, as shown in the change from FIG. 9A to FIG. 9B, the upstream support member 54A rises with the vertical surface 54d of the upstream support member 54A pressed against the vertical cam surface 56d of the upstream cam member 56A. Further, the downstream support member 61A rises with the vertical surface 61d of the downstream support member 61A pressed against the vertical cam surface 63d of the downstream cam member 63A.

When the line head 40 further rises, as illustrated in FIG. 9C, the upstream support member 54A is separated from the vertical cam surface 56d of the upstream cam member 56A, and the upstream support member 54A moves in the +Y direction by the pressing force of the coil spring 67. Concurrently, the inclined surface 54c of the upstream support member 54A is guided in the +Y direction by the inclined cam surface 56e of the upstream cam member 56A.

Further, the downstream support member 61A is separated from the vertical cam surface 63d of the downstream cam member 63A, and the downstream support member 61A moves in the −Y direction by the pressing force of the coil spring 67. Concurrently, the inclined surface 61c of the downstream support member 61A is guided in the −Y direction by the inclined cam surface 63e of the downstream cam member 63A.

When the line head 40 moves to the retracted position shown in FIG. 9D, the upstream support member 54A is separated from the upstream cam member 56A, the upstream support member 54A further moves in the +Y direction by the pressing force of the coil spring 67, and the upstream movable roller 53 is displaced to the second position. Further, the downstream support member 61A is separated from the downstream cam member 63A, the downstream support member 61A further moves in the −Y direction by the pressing force of the coil spring 67, and the downstream movable roller 60 is displaced to the second position.

As described above, the upstream movable roller 53 and the downstream movable roller 60 are retracted from the first position where the rollers are allowed to interfere with the wiper 36 and move to the second position, and thus the head surface 42a can be wiped by the wiper 36. When the line head 40 falls toward the recording position from the state in FIG. 9D, a state change opposite to the above-described state change occurs, the upstream cam member 56A presses the upstream support member 54A in the −Y direction against the pressing force of the coil spring 67, and the upstream movable roller 53 is displaced from the second position to the first position. Further, the downstream cam member 63A presses the downstream support member 61A in the +Y direction against the pressing force of the coil spring 67, and the downstream movable roller 60 is displaced from the second position to the first position.

As described above, the contact members can be displaced in conjunction with the displacement movement of the line head 40 with the simple configuration including the upstream support member 54A and the upstream cam member 56A, and the downstream support member 61A and the downstream cam member 63A.

As described above, the displacement mechanisms that displace the contact members, that is, the upstream displacement mechanism 52A and the downstream displacement mechanism 59A convert the displacement movement of the line head 40 into the displacement movement of the contact members, displace the contact members from the first position to the second position when the line head 40 is displaced from the recording position to the retracted position, and displace the contact members from the second position to the first position when the line head 40 is displaced from the retracted position to the recording position. This eliminates the need for a power source for displacing the contact members, and thus an increase in cost of the apparatus can be suppressed.

In the present embodiment, the contact members are displaced to the first position and the second position by moving in the directions intersecting the head surface 42a. Accordingly, an increase in size of the line head 40 in the medium conveyance direction can be suppressed compared to a configuration in which the contact members move along the medium conveyance direction.

Further, in the present embodiment, since the upstream movable roller 53 and the downstream movable roller 60, that is, the contact members are displaced to the first position and the second position by moving in the directions along the medium conveyance direction, an increase in size of the line head 40 in directions intersecting the head surface 42a can be suppressed compared to a configuration in which the contact members move in the intersecting directions.

The positions of the respective rollers in the present embodiment will be described with reference to FIG. 7.

In the media corresponding to the ranges P1, P2, and P3, the contact of the end portions in the medium width direction with the head surface 42a is suppressed by the upstream fixed rollers 47 and the downstream movable rollers 60.

In the medium corresponding to the range P4 or the medium having a size larger than the range P4, the contact of the end portions in the medium width direction with the head surface 42a is suppressed by the upstream movable rollers 53 and the downstream fixed rollers 48.

The upstream movable roller 53 at the first position is located at a position overlapping the head chip 43 at the upstream side in the medium conveyance direction. The downstream movable roller 60 at the first position is located at a position overlapping the head chip 43 at the downstream side in the medium conveyance direction.

This is because the upstream movable roller 53 enters the upstream recess portion 42b, and the downstream movable roller 60 enters the downstream recess portion 42c.

Therefore, the contact of the end portions of the medium in the medium width direction with the head surface 42a can be suitably suppressed.

In the present embodiment, the downstream fixed roller 48 is disposed downstream of the upstream movable roller 53, and the upstream fixed roller 47 is disposed upstream of the downstream movable roller 60. The downstream fixed rollers 48 are disposed downstream of the two upstream fixed rollers 47 located in the range P1.

According to the above-described configuration, the contact of the media corresponding to the ranges P1, P2, and P3 with the head surface 42a is first suppressed by the upstream fixed rollers 47 along with the conveyance, and then the contact with the head surface 42a is suppressed by the downstream movable rollers 60.

The contact of the medium corresponding to the range P4 with the head surface 42a is first suppressed by the upstream fixed rollers 47 along with the conveyance, then the contact with the head surface 42a is suppressed by the two upstream movable rollers 53 and the two downstream movable rollers 60, and then the contact with the head surface 42a is suppressed by the downstream fixed rollers 48.

According to the above-described configuration, the contact of the medium with the head surface 42a is suitably suppressed.

Other features of the respective embodiments will be described below.

In each of the embodiments described above, as illustrated in FIGS. 6A to 6C and FIGS. 9A to 9D, the plurality of contact members are provided when viewed from the medium width direction, and the plurality of contact members include the upstream movable roller 53 as a first contact member and the downstream movable roller 60 as a second contact member located downstream of the first contact member in the medium conveyance direction. Accordingly, the contact of the medium with the head surface 42a can be suitably suppressed.

The line head 40 includes the plurality of head chips 43 having nozzles 44 on the head surface 42a. The plurality of head chips 43 are alternately disposed at the upstream positions and the downstream positions in the medium conveyance direction along the width direction. The upstream recess portion 42b for avoiding the head chips 43 is provided upstream in the medium conveyance direction on the head surface 42a. Further, the downstream recess portion 42c for avoiding the head chips 43 is provided downstream in the medium conveyance direction. At the first position, the contact members enter the upstream recess portion 42b and the downstream recess portion 42c.

Accordingly, the contact members can be brought close to the center position of the head surface 42a in the medium conveyance direction. As a result, the contact of the medium with the head surface 42a can be suitably suppressed.

Note that only one of the upstream recess portion 42b and the downstream recess portion 42c may be provided as the recess portion. That is, only one of the upstream movable roller 53 and the downstream movable roller 60 may be provided.

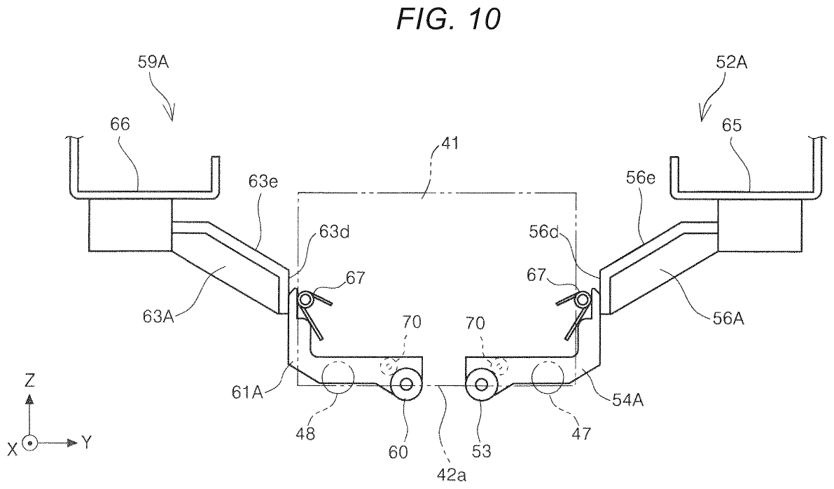

It is also preferable to provide a cleaning member for cleaning the contact member at a position where the cleaning member can come into contact with the contact member. FIG. 10 shows such an embodiment, and Sign 70 denotes a cleaning roller which is an example of the cleaning member. The cleaning roller 70 can be formed using a material that can absorb ink, for example, felt. The cleaning rollers 70 are driven to rotate in contact with the upstream movable roller 53 and the downstream movable roller 60 to absorb the ink attached to the upstream movable roller 53 and the downstream movable roller 60.

According to the configuration, reattachment to the medium of the ink attached to the contact members can be suppressed.

The present disclosure is not limited to the above-described embodiments and modifications. Various modifications can be made within the scope of the disclosure set forth in What is claimed is. It is obvious that the modifications also fall within the scope of the present disclosure.

What is claimed is:

1. A liquid ejection apparatus comprising:
a liquid ejection head including a plurality of nozzles that eject liquid onto a medium;
a facing portion disposed to face the liquid ejection head;
a wiper that wipes a head surface with the nozzles provided thereon in the liquid ejection head by moving with respect to the head surface to wipe the head surface; and
at least one contact member provided integrally with the liquid ejection head and configured to come into contact with the medium conveyed between the head surface and the facing portion, wherein
the contact member is displaceable between a first position and a second position that are relative positions to the head surface,
the first position is a position at which the contact member is allowed to interfere with the wiper and come into contact with the medium, and
the second position is a position at which the contact member is not allowed to interfere with the wiper.

2. The liquid ejection apparatus according to claim 1, wherein
the liquid ejection head is displaceable between a recording position where recording is performed on the medium and a retracted position farther from the facing portion than the recording position, at which the wiper is received between the head surface and the facing portion,
the contact member is located at the first position when the liquid ejection head is at the recording position,
the contact member is located at the second position when the liquid ejection head is at the retracted position, and
a displacement mechanism that displaces the contact member converts a displacement movement of the liquid ejection head into a displacement movement of the contact member, displaces the contact member from the first position to the second position when the liquid ejection head is displaced from the recording position to the retracted position, and displaces the contact member from the second position to the first position when the liquid ejection head is displaced from the retracted position to the recording position.

3. The liquid ejection apparatus according to claim 2, wherein
the contact member is displaced to the first position and the second position by moving in directions intersecting the head surface.

4. The liquid ejection apparatus according to claim 3, wherein
the displacement mechanism includes:
a support member supporting the contact member and configured to change an attitude to a first pivot attitude to set the contact member at the first position and a second pivot attitude to set the contact member at the second position by pivoting; and
a cam member provided independently of the liquid ejection head and configured to engage with the support member, wherein
the cam member guides the support member from the first pivot attitude to the second pivot attitude when the liquid ejection head is displaced from the recording position to the retracted position, and guides the support member from the second pivot attitude to the first pivot attitude when the liquid ejection head is displaced from the retracted position to the recording position.

5. The liquid ejection apparatus according to claim 2, wherein
the contact member is displaced to the first position and the second position by moving in directions along a conveyance direction of the medium.

6. The liquid ejection apparatus according to claim 5, wherein
the displacement mechanism includes:
a support member that supports the contact member and moves in the directions along the conveyance direction of the medium to switch the contact member between the first position and the second position;
a pressing member that presses the contact member toward the second position; and
a cam member provided independently of the liquid ejection head, and configured to engage with the support member when the liquid ejection head is at the recording position and to be separated from the support member when the liquid ejection head is at the retracted position, wherein
when the liquid ejection head is at the recording position, the cam member holds the contact member at the first position against a pressing force of the pressing member,
when the liquid ejection head is displaced from the recording position to the retracted position, the support member is separated from the cam member, and the contact member is displaced from the first position to the second position by the pressing force of the pressing member, and
when the liquid ejection head is displaced from the retracted position to the recording position, the cam member presses the support member against the pressing force of the pressing member, and the contact member is displaced from the second position to the first position.

7. The liquid ejection apparatus according to claim 1, comprising a plurality of the contact members when viewed from a width direction intersecting a conveyance direction of the medium, wherein
the plurality of contact members include a first contact member and a second contact member located downstream of the first contact member in the conveyance direction.

8. The liquid ejection apparatus according to claim 1, wherein
the liquid ejection head includes a plurality of head chips having the nozzles on the head surface,
the plurality of head chips are alternately disposed at an upstream position and a downstream position in a conveyance direction of the medium along a width direction intersecting the conveyance direction,
a recess portion for avoiding the head chips is provided on at least one of an upstream side and a downstream side in the conveyance direction on the head surface, and
the contact member enters the recess portion when the contact member is at the first position.

9. The liquid ejection apparatus according to claim 1, wherein
the liquid ejection head is a line head including the nozzles along a width direction intersecting a conveyance direction of the medium, and
the wiper wipes the head surface by moving from one end to the other end of the liquid ejection head in the width direction and further moving to a position away from the head surface.

10. The liquid ejection apparatus according to claim 1, wherein
the contact member is a roller that is rotatable in contact with the medium and is a toothed roller having teeth on an outer periphery.

11. The liquid ejection apparatus according to claim 10, comprising a cleaning member that cleans the contact member at a position where the cleaning member is allowed to come into contact with the contact member.
